(19) United States
(12) Patent Application Publication
(10) Pub. No.: US 2019/0200098 A1
(43) Pub. Date: Jun. 27, 2019

(54) Providing Enrichment Data That is a Sequence of Content Items

(71) Applicant: COMIGO LTD., Yarkona (IL)

(72) Inventors: Motty LENTZITZKY, Tel Aviv (IL); Menahem LASSER, Kohav-Yair (IL)

(21) Appl. No.: 16/223,149

(22) Filed: Dec. 18, 2018

Related U.S. Application Data
(60) Provisional application No. 62/610,242, filed on Dec. 25, 2017.

(51) Int. Cl. H04N 21/81; H04N 21/482; H04N 21/2668

(52) U.S. Cl. CPC H04N 21/8133; H04N 21/2668; H04N 21/4825

(57) ABSTRACT

Methods and systems for presenting, on a user's screen, enrichment data related to a displayed content item, the enrichment data comprising a sequence of related multiple content units, each one of which is (i) is either a content item or a video segment that is a portion of a larger video content item, (ii) has a connection to the displayed content item, (iii) is independent of all other related content units of the multiple related content units, and (iv) is not included in the displayed content item.

### CROSS-REFERENCE TO RELATED APPLICATIONS

This patent application claims the benefit of U.S. Provisional Patent Application No. 62/610,242 filed on Dec. 25, 2017, which is incorporated herein by reference in its entirety.

### FIELD OF THE INVENTION

The present invention relates to systems and methods for enhancing user experience for a user consuming a content item, by displaying related content having a connection with the content item. In particular, the present invention relates to enhancing user experience by displaying, one after the other, a sequence of multiple content items of the related content.

### BACKGROUND

When TV technology first became commercially available to the public, users could only consume video content items at their homes under fixed pre-determined schedules and in a linear way. That is—a user could only watch a movie or a news program at the time a broadcaster decided to broadcast it, and no deviation from the pre-defined program schedule was possible. The only flexibility a user had was the selection of which channel to display on one's TV screen, thus selecting between multiple video content items that are simultaneously aired.

At a later stage Video-On-Demand (VOD) was offered to the users. This service enabled them to consume content not appearing on the current programs schedule, and resulted in a significant increase in flexibility when deciding what to watch. Another boost in user flexibility was achieved when TV operators introduced Catch-Up TV services which not only allow a user to pick any program recently offered in the EPG (Electronic Program Guide), but also allows him to jump backward and forward in time within a specific program and to freeze and resume the playing of a program.

The next step in the process of increasing user flexibility and freedom of choice was reached when some advanced Set-Top Boxes (STBs) started offering means for navigation between different media content items. For example, a user currently watching (or just finishing watching) a movie which is about a crime mystery in Australia may ask the TV system to propose to him options for watching another media content item that is related to the currently watched movie or for watching other information related to that movie. He may then be presented with a list of options that includes:

a. One or more other crime mystery movies

b. One or more other movies with the plot occurring in Australia

c. One or more other movies having the same director as the current movie

d. One or more other movies with an actor or an actress that also appears in the current movie

e. A review of the current movie by the New York Times

f. A biography of the main actress of the current movie

g. A still picture of the main actress of the current movie

h. A graphic animation that is based on the plot of the current movie

The user can then select a member of the list and in response will be presented with the selected movie or with the selected other information.

This linking of media content items to related other media content items and/or to related other information brought user flexibility and freedom of choice to new levels not available before.

An additional improvement in that direction occurred when still more advanced STBs started proposing related media content items and related non-media content items that are not necessarily related to the currently played media content item as a whole, but are related to specific portions of a currently playing media content item or are related to specific entities appearing for a short period of time in a currently playing media content item. For example, a short appearance of a certain geographical location (for example the UN building in New York City) in a movie or in a news program may trigger the offering to the user of media content items and/or other information items that are related to that location. The user may for example be presented with a list of options that includes:

a. One or more movies whose plot (at least partially) occurs in the UN building.

b. One or more movies whose plot (at least partially) deals with diplomatic relations between states.

c. An article about the history of the UN organization.

d. A biography of the current General Secretary of the UN organization.

e. A still picture of the first General Secretary of the UN organization.

This linking of entities embedded within media content items to related media content items and/or to other types of related information brought user flexibility and freedom of choice to further new levels not available before.

The providing of recommendation for content items related to what a user is currently viewing is not limited to TV systems. With more and more content viewing moving from the TV screen to the computer screen and the phone screen, a similar development had occurred in the Internet browsing experience. In many websites (such as YouTube, CNN, Fox News), while a user is watching a content item, he sees recommendations for related content items.

The recommendations are presented in the form of hot links, that when selected by the user (for example by clicking them with a mouse), take the user to the linked content item. A link is typically shown together with a textual title (part or all of which may serve as the text acting as the hot link). For a video content item or a still picture content item, the link may also be shown together with a thumbnail image or with a small video window.

The recommendations may be for other content items in the same website, as is the case when other YouTube video content items are proposed during the watching of the currently watched YouTube video content item. Alternatively, the recommendations may include (or even consist only of) recommendations for other content items that are located in other websites. For example, some Internet news websites provide recommended links that are a mix of links to the same website as the currently watched content item and links to other news websites.

Regardless of the type of content item whose watching triggers the presentation of the recommendations (e.g. video, text) and regardless of the type of viewing device (e.g. TV screen, computer, phone), a triggered recommendation may point to a media content item (such as a video content item or a music content item) or to a non-media content item (such as a paragraph of text).

Co-pending U.S. patent application Ser. No. 16/149,175, titled “Providing Enrichment Data that is a Video Segment” and filed Oct. 2, 2018, which is fully incorporated herein by reference, further extends the scope of recommendation systems by disclosing a recommendation system in which a recommendation may be for a video segment which is a portion of a larger video content item, where the larger video content item is strictly larger than the video segment. In other words, accepting a recommendation may lead to the playing of only a portion of a video content item.

In prior art systems providing recommendations of related content items, after a user selects one recommendation from the multiple recommendations proposed to him by the system, a single content item is displayed—the content item picked by the user.

This behavior is not always the optimal behavior from the user's point of view. For example, the user may be watching or has just watched a video news item about an ISIS terror attack in Iraq. Consequently, the recommendations system is proposing the following three content items: (i) a video news item about an ISIS terror attack in Yemen, (ii) a video news item about an ISIS terror attack in Syria, and (iii) a documentary movie about Iraq's history. As expected, all three proposed content items are related to what the user is watching or has just watched.

The user may review the list of recommendations and decide that all three of them are of interest to him and he would like to watch them all. He now picks the Yemen item to be the first to be watched. When finished with the Yemen item, the user now wants to watch the Iraq history documentary. However, the recommendations now presented to him are all related to the Yemen terror attack item. They include: (i) the previously-proposed video news item about an ISIS terror attack in Syria, (ii) a video news item about an ISIS terror attack in France, and (iii) a documentary movie about Yemen's history.

The user now wants to watch the documentary movie about Iraq's history that was proposed to him earlier. However, that recommendation is not offered now and is not available for selection, as it is not related to the most recently watched item—the news item about the ISIS terror attack in Yemen. The best the user can now do is to select the video news item about the ISIS terror attack in Syria, which is still available. But after watching the Syria item, the user would still not be able to select the Iraq documentary, as it will not be proposed to him because it is not related to the recently watched item about Syria.

In the above case, the user could conveniently watch two of the three recommendations he was interested in, but this is not always the case. Suppose the user had initially picked the Iraq documentary movie as the first item to watch out of the three items of interest. When finished with that documentary, the recommendations now presented to him may be: (i) a documentary movie about the history of Iran, (ii) a video news item about Iraq's economic recovery, and (iii) a documentary movie about the cultural relations between Iraq and Iran throughout history. The user now realizes that both of the two initial recommendations he has not watch yet (the ISIS terror attacks in Yemen and Syria) are not available now, because the recommendations system does not find them to be related to the most recently watched item about Iraq's history. So in this case, once the user had made his initial selection, all the other proposals in the list become unavailable to him.

One may argue that the above issue may be resolved by the user going back to the watching the initial content item (the video news item about the ISIS terror attack in Iraq, in this example), and then all the initial recommendations would become available again. The going back may be achieved by the user selecting the “Back” arrow in his browser.

However, even if this would have always worked, it would be an inconvenience for the user, especially if the initial content item is a video content item and the user has to watch it to its end before the desired recommendations show up. But in reality the solution of going back does not always work—the list of recommendations proposed when returning to a previously-watched content item is not always the same list that was proposed when the user previously watched that content item.

First, many recommendation systems are adaptive—attempting to learn the user's preferences based on his selections and adjusting their recommendations accordingly. For example, in the above first case of the user initially selecting the item about the ISIS terror attack in Iraq, the recommendations system may conclude from the selection that the user's main interest lies in ISIS terror attacks rather than in historical documentaries, and therefore, when the user comes back to the initial item of ISIS attack in Iraq, the recommendations now proposed to him might be: (i) the initially-proposed video news item about an ISIS attack in Syria, (ii) the previously-proposed video news item about an ISIS attack in France, and (iii) a newly-proposed video news item about an ISIS terror attack in the UK. So in spite of going back to the initial item, the user can still not access the Iraqi history documentary.

Second, many recommendation systems are not deterministic in their recommendations. The potential list of recommendations that are related to a given content item is typically much longer that the list of recommendations proposed to the user, due to screen space limitations or due to human-interface considerations. Therefore, many recommendation systems show only a subset of the recommendations they find relevant to a given content item, and when the user comes back to the same given content item, they pick a different subset. This is done in order to expose the user to recommendations he could not see before. The two different subsets can be disjoint or can have some items in common, but in both cases there is no guarantee that a recommendation that was proposed during or after a first consumption of a given content item will be proposed again during or after a second consumption of that given content item.

One may again argue that the above issue of repeatability of recommendations may be resolved by the user opening a new window for watching each recommendation, so that the original list of recommendations remains available in the previous window in which the initial content item had been watched. However, this requires the user to either set up his browser to always open a new window whenever a link is selected, or to explicitly instruct his browser to open a given link in a new window, for example by pressing the central mouse button instead of the usually-used left button. This in turn adds to the inconvenience, as the user has to maneuver between different windows and employ multiple mouse buttons, instead of using the natural way of selecting links by pressing the left mouse button and staying within a single window. Moreover, this option is not necessarily available in non-browser-based distribution channels.

There is thus a need to provide a way for a user to watch multiple recommendations related to a currently watched or just watched content item in a natural and convenient way.

Some prior art recommendation systems can display multiple recommended content items or segments of content items, for example in the case of multiple episodes of a TV series or weekly radio program. A similar example is the case of recommending multiple highlight segments of a specific video content item. However, these examples address special cases where the multiple recommendations are not independent from each other. There is still a need for a general solution for continuously watching in a natural and convenient way a sequence of recommended content items and/or segments of content items, all of which are related to a currently-watched or just-watched content item, where the items in the sequence are not related to each other but are rather independently-recommended items.

### SUMMARY

A method is disclosed, according to embodiments, for enhancing user experience for a user consuming a content item by displaying a sequence of multiple content units related to the content item. The method comprises (a) causing the content item to be displayed by a content playing device; (b) during the displaying of the content item by the content playing device, determining related content having a connection to the displayed content item, the determined related content including multiple content units, where each content unit (i) is either a content item or a video segment that is a portion of a larger video content item, (ii) has a connection to the displayed content item, (iii) is independent of all other content units included in the related content, and (iv) is not included in the displayed content item; (c) causing an option to display the related content to be presented to the user; and (d) in response to acceptance of the option by the user, causing the related content to be displayed by the content playing device, where the displaying of the related content includes displaying all of the plurality of content units included in the related content one after another.

In some embodiments, the displaying of all the content units included in the related content one after another can include displaying all of the content units in sequence, without receiving any input from the user between the displaying of successive content units. In such embodiments, it can be that one of the content units included in the related content is a textual content item, and during the displaying of the related content, the textual content item is displayed for a pre-defined time interval. Also in such embodiments, it can be that one of the content units included in the related content is a textual content item, and, during the displaying of the related content, the textual content item is displayed for a time interval that depends on one or more characteristics of the textual content item.

In some embodiments, the displaying of all the content units of the related content one after another can include receiving confirmation from the user between the displaying of successive content units.

In some embodiments, the method can further comprise additionally causing at least one option to display only one of the multiple content units included in the related content to be displayed to the user.

In some embodiments, at least one of the multiple content units included in the related content can be a video segment. In some embodiments, all the multiple content units included in the related content can be video segments.

In some embodiments, for at least one content unit included in the related content, the connection of the one content unit to the displayed content item can be a connection of the one content unit to the displayed content item as a whole. In some embodiments, it can be that: (i) the content item is a video content item, and (ii) for at least one content unit included in the related content, the connection of the one content unit to the displayed content item is a connection of the one content unit to a scene in the displayed content item. In some embodiments, for at least one content unit included in the related content, the connection of the one content unit to the displayed content item can be a connection of the one content unit to a named entity identified in the displayed content item.

In some embodiments, the determining of the related content having a connection to the displayed content item can include analyzing a video channel of the content item. In some embodiments, the determining of the related content having a connection to the displayed content item can include analyzing an audio channel of the content item. In some embodiments, the determining of the related content having a connection to the displayed content item can include analyzing subtitles of the content item. In some embodiments, the determining of the related content having a connection to the displayed content item can include analyzing metadata of the content item. In some embodiments, the determining of the related content having a connection to the displayed content item can include analyzing text included in the content item.

In some embodiments, the determining of the related content having a connection to the displayed content item can be based on a user preference obtained by analyzing viewing history of the user. In some embodiments, the determining of the related content having a connection to the displayed content item can be based on a user preference manually provided by the user.

In some embodiments, the displaying of the related content can be done during the displaying of the displayed content item by the content playing device. In some embodiments, for at least one point in time, the displayed content item and the related content are being displayed simultaneously.

In some embodiments, the method can further comprise: (e) during the displaying of the displayed content item by the content playing device, receiving a request from the user to propose related data that is connected to the displayed content item, wherein the option is presented in response to the receiving of the request.

In some embodiments, the displayed content item can include a media content item. In such embodiments, the media content item can include a video content item, in which case the content playing device can be one of a TV screen, a computer screen and a phone screen.

In some embodiments, the displayed content item can include a non-media content item. In such embodiments, the non-media content item can include a paragraph of text, in which case the content playing device can be one of a computer screen and a phone screen.

A system for distributing video content is disclosed, wherein the system comprises (a) a content-item distribution module; (b) a visual-enrichment-data distribution module; (c) one or more computer processors; and (d) a non-transitory computer-readable storage medium storing program instructions for execution by the one or more computer processors, the non-transitory computer-readable storage medium having stored therein: (i) first program instructions that, when executed by the one or more processors, cause the content-item distribution module to cause the content item to be displayed by a content playing device; (ii) second program instructions that, when executed by the one or more processors, cause the visual-enrichment-data distribution module to determine, during the displaying of the content item by the content playing device, related content having a connection to the displayed content item, the determined related content including multiple content units, where each content unit (A) is either a content item or a video segment that is a portion of a larger video content item, (B) has a connection to the displayed content item, (C) is independent of all other content units included in the related content, and (D) is not included in the displayed content item; (iii) third program instructions that, when executed by the one or more processors, cause the visual-enrichment-data distribution module to cause an option to display the related content to be presented to the user; and (iv) fourth program instructions that, when executed by the one or more processors, cause the visual-enrichment-data distribution module to cause the related content to be displayed by the content playing device in response to acceptance of the option by the user, where the displaying of the related content includes displaying all of the plurality of content units included in the related content one after another.

A method is disclosed, according to embodiments, for enhancing user experience for a user consuming a content item by displaying a sequence of multiple content units related to the content item. The method comprises (a) causing the content item to be displayed by a content playing device; (b) during the displaying of the content item by the content playing device, determining multiple related content units, where each related content unit of the multiple related content units (i) is either a content item or a video segment that is a portion of a larger video content item, (ii) has a connection to the displayed content item, (iii) is independent of all other related content units of the multiple related content units, and (iv) is not included in the displayed content item; (c) for each of at least two related content units of the multiple related content units, causing an option to display the respective related content unit to be presented to the user; (d) receiving from the user, for at least two of the related content units for which an option was presented, a positive decision to activate the respective option; and (e) causing the at least two related content units for which a positive decision to activate the respective option was received to be displayed one after another by the content playing device.

In some embodiments, the displaying of all of the at least two related content units one after another can include displaying all of the at least two related content units in sequence, without receiving any input from the user between the displaying of successive related content units. In such embodiments, it can be that one of the at least two displayed related content units is a textual content item and is displayed for a pre-defined time interval. Also in such embodiments, it can be that one of the at least two displayed related content units is a textual content item and is displayed for a time interval that depends on one or more characteristics of the textual content item.

In some embodiments, the displaying of the at least two related content units one after another can include receiving confirmation from the user between the displaying of successive related content units.

In some embodiments, at least one of the at least two displayed related content units can be a video segment. In some embodiments, all of the at least two displayed related content units can be video segments.

In some embodiments, for at least one of the at least two displayed related content units, the connection to the displayed content item is a connection to the displayed content item as a whole. In some embodiments, it can be that: (i) the displayed content item is a video content item, and (ii) for at least one of the at least two displayed related content units, the connection to the displayed content item is a connection to a scene in the displayed content item. In some embodiments, for at least one of the at least two displayed related content units, the connection to the displayed content item can be a connection to a named entity identified in the displayed content item.

In some embodiments, the determining of the multiple related content units can include analyzing a video channel of the displayed content item. In some embodiments, the determining of the multiple related content units can include analyzing an audio channel of the displayed content item. In some embodiments, the determining of the multiple related content units can include analyzing subtitles of the displayed content item. In some embodiments, the determining of the multiple related content units can include analyzing metadata of the displayed content item. In some embodiments, the determining of the multiple related content units can include analyzing text included in the displayed content item.

In some embodiments, the determining of the multiple related content units can be based on a user preference obtained by analyzing viewing history of the user. In some embodiments, the determining of the multiple related content units can be based on a user preference manually provided by the user.

In some embodiments, the displaying of the at least two related content units can be done during the displaying of the displayed content item by the content playing device. In some embodiments, for at least one point in time the displayed content item and one of the at least two displayed related content units can be displayed simultaneously.

In some embodiments, the method can further comprise: (f) during the displaying of the displayed content item by the content playing device, receiving a request from the user to propose related data that is connected to the displayed content item, wherein, for at least one related content unit of the multiple related content units, the corresponding option is presented in response to the receiving of the request.

In some embodiments, the receiving from the user of each positive decision to activate the respective option can include receiving a state of a respective checkbox.

In some embodiments, the order according to which the at least two displayed related content units are displayed can be determined according to the order of receiving the respective positive decisions from the user.

In some embodiments, the order according to which the at least two displayed related content units are displayed can be automatically determined, without being affected by user inputs. In such embodiments, the order according to which the at least two displayed related content units are displayed can be determined based on corresponding length values associated with the at least two displayed related content units. Also in such embodiments, the order according to which the at least two displayed related content units are displayed can be determined based on corresponding size values associated with the at least two displayed related content units. Also in such embodiments, the order according to which the at least two displayed related content units are displayed can be determined based on corresponding calendar times associated with the at least two displayed related content units. Also in such embodiments, the order according to which the at least two displayed related content units are displayed can be randomly determined.

In some embodiments, the displayed content item can include a media content item. In such embodiments, the media content item can include a video content item, in which case the content playing device can be one of a TV screen, a computer screen and a phone screen.

In some embodiments, the displayed content item can include a non-media content item. In such embodiments, the non-media content item can include a paragraph of text, in which case the content playing device can be one of a computer screen and a phone screen.

A system for distributing video content is disclosed, wherein the system comprises: (a) a content-item distribution module; (b) a visual-enrichment-data distribution module; (c) one or more computer processors; and (d) a non-transitory computer-readable storage medium storing program instructions for execution by the one or more computer processors, the non-transitory computer-readable storage medium having stored therein: (i) first program instructions that, when executed by the one or more processors, cause the content-item distribution module to cause the content item to be displayed by a content playing device; (ii) second program instructions that, when executed by the one or more processors, cause the visual-enrichment-data distribution module to determine, during the displaying of the content item by the content playing device, multiple related content units, where each related content unit of the multiple related content units (A) is either a content item or a video segment that is a portion of a larger video content item, (B) has a connection to the displayed content item, (C) is independent of all other related content units of the multiple related content units, and (D) is not included in the displayed content item; (iii) third program instructions that, when executed by the one or more processors, cause the visual-enrichment-data distribution module to cause at least two options to be presented to the user, each option of the at least two options being an option to display one respective related content unit of the multiple related content units; (iv) fourth program instructions that, when executed by the one or more processors, cause the visual-enrichment-data distribution module to receive from the user, for at least two of the presented options, a positive decision to activate the respective option; and (v) fifth program instructions that, when executed by the one or more processors, cause the visual-enrichment-data distribution module to cause the at least two related content units for which a positive decision to activate the respective option was received to be displayed one after another by the content playing device.

### BRIEF DESCRIPTION OF THE DRAWINGS

FIG. 1 is a schematic illustration of a system for distributing content, causing the displaying of a video content item, and causing the displaying of related content, according to some embodiments.

FIG. 2 is a schematic illustration of a content-playing device offering a user related content, according to some embodiments.

FIG. 3 shows a schematic representation of a computer-readable storage medium and groups of program instructions stored thereon, according to some embodiments.

FIGS. 4 and 5 show flowcharts of methods for enhancing user experience for a user consuming a content item.

FIG. 6 is a schematic illustration of a system for distributing content, causing the displaying of a video content item, and causing the displaying of related content, according to some embodiments.

FIG. 7 is a schematic illustration of a content-playing device offering a user related content units, according to some embodiments.

FIG. 8 shows a schematic representation of a computer-readable storage medium and groups of program instructions stored thereon, according to some embodiments.

FIGS. 9 and 10 show flowcharts of methods for enhancing user experience for a user consuming a content item.

### DETAILED DESCRIPTION OF THE EMBODIMENTS

Note: Throughout this disclosure, subscripted reference numbers (e.g., 10₁) may be used to designate multiple separate appearances of elements in a single drawing, e.g. 10₁ is a single appearance (out of a plurality of appearances) of element 10. The same elements can alternatively be referred to without subscript (e.g., 10 and not 10₁) when not referring to a specific one of the multiple separate appearances.

The proposed solution provides recommendation of related content units, such that multiple recommended units may be conveniently watched.

As defined in the Definitions section, a “content unit” is a content item or a video segment. For the definitions of “content item” and “video segment”, see the Definitions section.

In a first embodiment of the proposed solution the recommendations system provides at least one recommendation that, when selected, results in the user immediately watching in a continuous way a sequence of content units that includes multiple content units. It should be noted that the terms ‘first embodiment’ and ‘second embodiment’ as used herein refer more precisely to respective families of embodiments of the invention which have several key features in common including, inter alia, whether related content units are presented to users as a collection of recommended content units or as individually selectable recommendations.

The multiple content units included in the sequence are arbitrary content units, the requirement being that they are all somehow related to the currently watched or just watched content item. Each member of the sequence may be a different program, movie, news item, etc., and there are not direct connections between different members of the sequence (such as being taken from the same TV series or from the same weekly radio program). Thus, the proposed solution is applicable to all the examples above, and as an example can play as a continuous sequence the items: (i) a video news item about an ISIS terror attack in Yemen, (ii) a video news item about an ISIS terror attack in Syria, and (iii) a documentary movie about Iraq's history.

Taking the above example of the user initially watching the video news item about the ISIS terror attack in Iraq, the list of recommendations may include a recommendation, that when selected, plays all three recommended items (the video news item about the ISIS terror attack in Yemen, the video news item about the ISIS terror attack in Syria, and the documentary movie about Iraq's history) as a continuous sequence that does not require user input until the end of the last included content item. In response to the selection, the system first plays the first recommendation (the Yemen item). Once this item gets to its end, the system automatically switches to the second recommendation (the Syria item) without waiting for user input. Once that item gets to its end, the system automatically switches to the third recommendation (the Iraq history documentary item), again without waiting to user input. Only when finishing playing all three recommendations, will the system stop playing and wait for user instructions.

The recommended sequence may be proposed to the user as an extra recommendation, in addition to providing one or more single-item recommendations (e.g. in addition to providing the three single-item recommendations of the above example). Alternatively, the recommendations list may include only recommendations to sequences of multiple content unit. For example, the recommendations system may identify four related content units—A, B, C and D. The system may then propose to the user the following options: (1) Watch A+B+C+D, (2) Watch A+B, and (3) Watch C+D. Optionally, the system may also include options for (4) Watch A+C and (5) Watch B+D, where partially-overlapping combinations are proposed as available options.

The proposed solution provides clear advantages when the recommended sequence contains content units that have a natural ending time, such as video content items and audio content items. For such content units, when included in a recommended sequence they are played up to their end, and then the next content unit in the sequence is automatically started.

However, the proposed solution may also be used when the recommended sequence contains content units that do not have a natural ending time, such as news items including only text. In such case the system may use a default time interval (e.g. one minute), and display each content unit for that time interval before automatically switching to the next content unit in the sequence. The length of the default time interval may be pre-defined by the system without providing the user any means of controlling it, or it may be settable by the user using the GUI or remote controller by which he controls the system.

Alternatively, the system may assign a specific time interval for each textual content item, based on its specific characteristics. For example, a textual content item that contains 50 words is assigned a 30 seconds time interval, while a textual content item that contains 200 words is assigned a 90 seconds time interval.

The continuous displaying of the content units of a sequence selected by the user may be fully automatic, without any user intervention. In other words, once one unit comes to an end (or reaches the end of its pre-assigned time interval for textual content item), the next unit of the sequence is automatically started, without requiring any additional input from the user. Alternatively, when one unit comes to end, the user is prompted for confirming that the displaying of the sequence should be continued. The user then has an option to confirm (in which case the displaying of the next unit starts) and an option to refuse to confirm (in which case the displaying of the sequence is stopped).

When the single-item recommendations are recommendations for video content units, the teachings of U.S. patent application Ser. No. 16/149,175 may be used for also including video segments in the proposed sequences. In other words, a recommended sequence of video content units may include any of the following:

Multiple video content items

Multiple video segments

One or more video content items and one or more video segments

The segments included in a sequence are arbitrary segments that are not directly related to each other. For example, each segment is extracted from a different movie.

The ability to recommend a sequence of video segments and automatically display it in full provides a significant improvement in the viewing experience of the user. For example, a user may watch a movie that includes a car chase scene. In prior art systems, he may get several recommendations, each of which pointing to a car chase video segment in a different movie. In the proposed solution, the user may (additionally) get a recommendation for a sequence containing all the individual car chase video segments. When selecting that recommendation, the user will see the full collection of car chase segments being continuously played without requiring any additional involvement on his part.

In some implementations of this embodiment, once a recommended sequence is selected and starts being displayed, the user cannot interrupt it until it ends. In other implementations, the user cannot interrupt the sequence in the middle of a content unit, but is given an ability to interrupt it between units. In still other implementations, the user may interrupt the sequence at any time, including in the middle of displaying a content unit within the sequence.

In cases in which the user may interrupt the displaying of a sequence, he may pause and resume the displaying, abort the sequence, abort the current content unit and immediately jump to the next one, restart displaying the current content unit and jump back to the previously displayed content unit. Each of the above operations may have its own limitations on time of use, according to the above implementations. For example, the user may be able to pause and resume the displaying of the sequence at any time, including in the middle of a content unit. But he may be able to jump to the next or previous content units only during a short window of time between the end of one unit to the beginning of the next unit.

While video content units are being played within a recommended sequence of video content units, the recommendation system may provide the user with other recommendations that are related to the currently playing video content unit. Those recommendations may be related to the specific video content unit that is currently playing, in which case the recommendation may automatically change when the system switches from one unit of the playing sequence to the next, or even within a single unit. Alternatively, those recommendations may be related to a topic that is a common denominator of the whole sequence of video content units, in which case the recommendations may stay the same throughout the playing of the sequence.

The user may have an option to enable or disable the feature of providing recommendations of sequences of content units. This option may be activated or deactivated by the user using the GUI or remote controller by which he controls the system.

In a second embodiment of the proposed solution the recommendations system provides the user with an ability to manually instruct the system to create a sequence of content units and continuously display it.

The list of the single-item recommendations is presented to the user with a small check-box attached to each recommendation. The user checks those recommendations he wants to watch, by checking the boxes of all the desired recommendations. After doing that, the user tells the system (e.g. by pressing a button in the remote controller or by pressing a button on the screen using the mouse) to start displaying. The system then displays the group of checked recommended items as if it is an automatically-generated sequence, according to the description provided above for the first embodiment.

For the above example of the user watching the video news item about the ISIS terror attack in Iraq, and the system providing three single-item recommendations (the video news item about the ISIS terror attack in Yemen, the video news item about the ISIS terror attack in Syria, and the documentary movie about Iraq's history), there will be three check-boxes, one per recommendation. The user checks the boxes corresponding to the second and the third recommendations (but not the check box corresponding to the first recommendation), and when the sequence is played, only those two items are played and not the first one.

The check-boxes described above are just an example, and any other means of providing selection input to the system may be used.

The order according to which the marked content units are displayed within the sequence may be according to the selection order by which the user marked the check-boxes. So in the above example, if the user first marked the third item and then marked the second item, the third item will be displayed before the second item.

Alternatively, the order according to which the marked content units are displayed within the sequence may be according to the order of presenting the proposals to the user. So in the above example, even if the user first marked the third item and then marked the second item, the second item will be displayed before the third item.

In such case, the order according to which the marked content units are displayed within the sequence may be automatically determined by the system according to some criteria. For example, the order may be from the oldest item to the newest, from the newest item to the oldest, from the shortest item to the longest, from the longest item to the shortest, etc. Alternatively, the order may be automatically set according to a random rule, resulting in different order for each case.

The user may have an option to enable or disable the feature of manually selecting multiple recommendations for creating sequences of content units. This option may be activated or deactivated by the user using the GUI or remote controller by which he controls the system. When deactivated, no check-boxes or other GUI selection means are available to the user.

Except for what is explicitly said here about the second embodiment, the second embodiment may employ any feature and method of the first embodiment and may operate in the same manner as the first embodiment, as described above for the first embodiment.

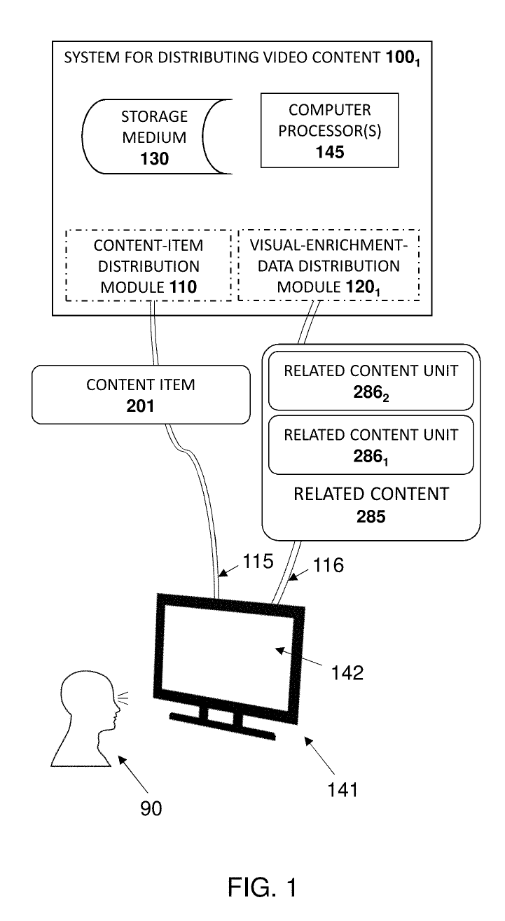

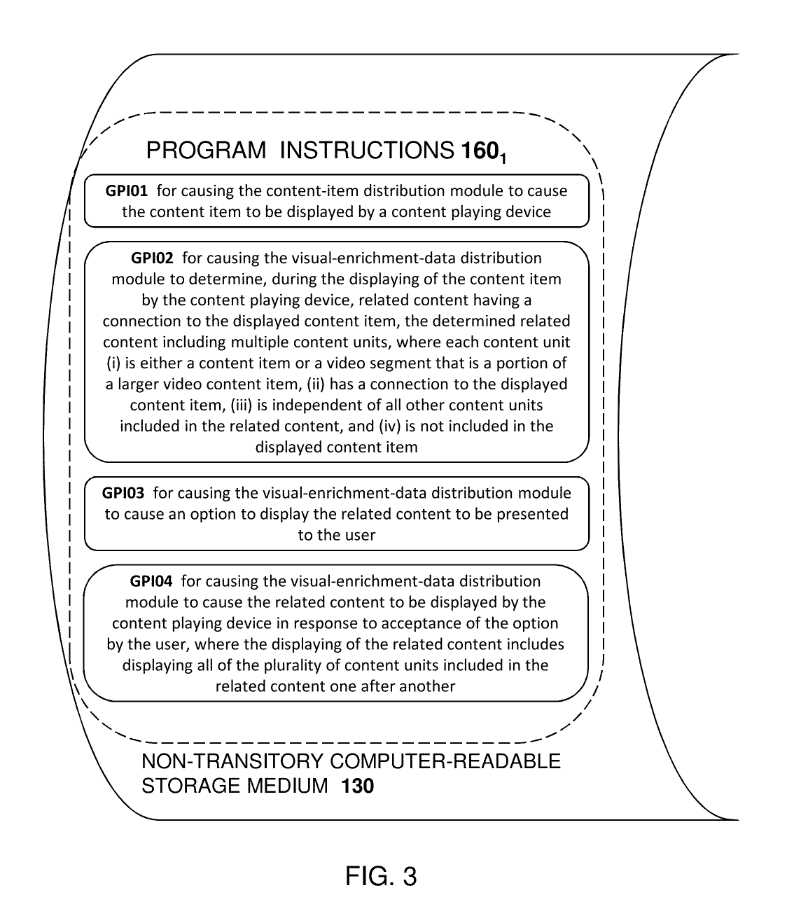

Referring now to the figures, and in particular to FIG. 1, a system 100₁ for distributing video content is illustrated, where the system 100₁ comprises a content-item distribution module 110, a visual-enrichment-data distribution module 120₁; one or more computer processors 145, and a non-transitory computer-readable storage medium 130 storing program instructions 160₁ (not shown in FIG. 1). Examples of stored program instructions 160₁ according to the first embodiment discussed above are shown in FIG. 3 and are discussed later in this disclosure. Both the content-item distribution module 110 and the visual-enrichment-data distribution module 120₁ are in at least indirect communication via respective communications channels 115, 116 with a content-playing device 141 of a user 90. The content-playing device can be any content-playing device 141 having a screen 142 for displaying content, including video content, such as, for example, a television, a computer (desktop, notebook, tablet, etc.) or a smartphone. Communications channels 115, 116 can include any communications technology known in the art for delivering video content or other content, whether wired or wireless or both, and including, but not exhaustively, over-the-air broadcast television systems, cable television systems, over-the-Internet television systems (e.g. IPTV or OTT), and satellite televisions systems. Content-item distribution module 110 is operable to deliver a content item 201, for example according to a schedule or on-demand, to the user's content-playing device 141. The expression “deliver to the content-displaying device 141” as used herein or any conjugate thereof means that the content item 201 is caused to be displayed on the content-playing device 141. Visual-enrichment-data distribution module 120₁ is operable to deliver enrichment data in the form of related content 285 to the user's content-playing device 141, for example upon user request as described earlier in this disclosure. Related content 285 can include any number of related content units 286₁, 286₂, etc. The ‘related’ content units 286 (RCUs) are so-named because they are related to the content item 201, although not to each other.

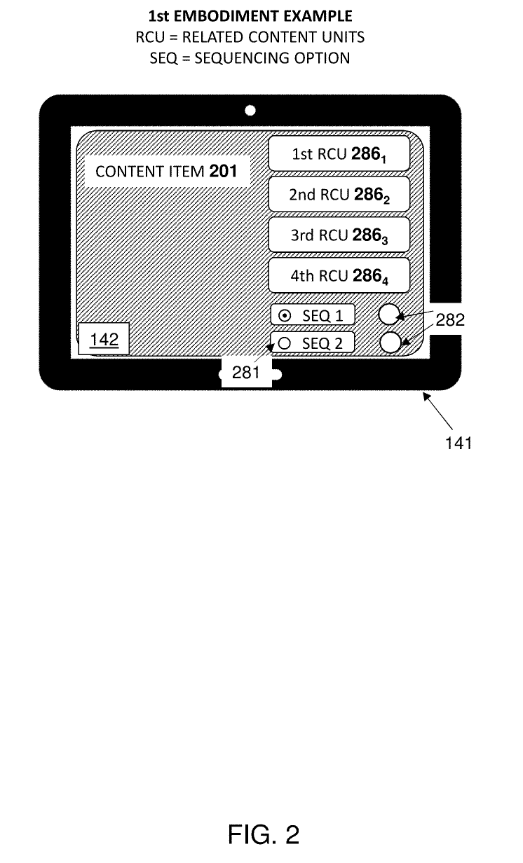

FIG. 2 shows a content-playing device 141 with a screen 142 on which a content item 201 is being displayed. In the non-limiting example of FIG. 2, recommendations for four related content units (RCUs) 286₁, 286₂, 286₃, 286₄ are presented to the user 90. Criteria for determining related content units for recommending were discussed earlier in this disclosure and are well known in the art. The recommendations are presented to the user either because the user instructed the visual-enrichment-data distribution module 120 to offer them, or because the user's profile indicates that the user always prefers to view recommendations. In other examples, more than 4 or fewer than 4 recommendations can be presented. An input field for Go/no-go options 282 (or play/cancel or any similar terminology) may be offered to user 90. Selecting ‘go’ instructs the visual-enrichment-data distribution module 120 to display the related content 285. Selecting ‘no’ cancels the possibility of displaying the recommended related content 285. In addition, two different sequence options are offered in the example of FIG. 2, each one with an input-enabling element such as a ‘radio button’ 281, i.e., an input-enabling element allowing exactly one of the options to be selected by a user. In the case example of FIG. 2, the first sequence (SEQ 1) is shown as selected. A set of radio buttons is not mandatory—instead, any kind of input-enabling element can be used. In some examples no additional input-enabling element such as a set of radio buttons is necessary, and the entire graphical or textual representation of each offered sequence option can be selectable with a cursor controlled by a mouse click or a remote-control button-press, or by tapping with a finger or stylus in the case of screen 142 being a touchscreen. Generally speaking, there are many possible sequences that can be offered to the user: 4! (factorial) options if all 4 RCU recommendations are included in the offered sequence. In alternative embodiments in which fewer than 4 RCUs are included in the offered sequence, then there are 3! possible sequence options for each of the 4 possible 3-RCU sets, and 2! for each of the 6 possible 2-RCU sets.

In the preceding paragraph and in other examples in this disclosure, the presenting of options to the user for the display and/or sequencing of related content units is described as being done by the content playing device, i.e., the options are presented on the same screen that displays the video content item. This convention has been adopted in the disclosure only for convenience, and any such options can alternatively (or, in some embodiments, additionally) be presented to the user on a secondary device such as a smartphone or a tablet. For example, a smartphone or tablet can be running an app that is in communication with the visual-enrichment-data distribution module, and allows the secondary device to serve as an input/output device for user decisions and selections with respect to the displaying of related content on the primary display device, i.e., the display device used by the content playing device for displaying the content item that is being displayed.

If the visual-enrichment-data distribution module 120 offers the user a choice of sequences—which in some cases it does not, but instead displays all of the presented RCUs 286 of the related content 285 in a predetermined sequence—it most likely cannot offer every possible sequence as an option if more than two recommended RCUs are involved. Therefore it can be useful to have the visual-enrichment-data distribution module 120 select a manageable number of pre-determined sequence options for offering as sequence options to the user. In a non-limiting example, the visual-enrichment-data distribution module 120 offers the sequences ‘1-2-3-4’, ‘2-3-4-1’, ‘3-4-2-1’ and ‘4-1-2-3’. In this example, all of the sequences present the same 4 recommendations for RCUs in the same order, but each option starts at a different place in the sequence. In some examples, the logic employed by the visual-enrichment-data distribution module 120 in ‘winnowing down’ the possible sequences to a manageable number can vary from user to user, or be specific to a type of displayed content item 201. In some examples, the offering of sequence options is itself optional, and only the go/no-go buttons 282 are present on the screen 142 so as to enable the user either to ‘launch’ (go) the displaying of the sequence of all proposed related content units in a pre-determined default order (go) or cancel (no go) the entire sequence.

We now refer to FIG. 3 in combination with FIG. 1. The system 100₁ for distributing video content, according to some embodiments, comprises a video-content-item distribution module 110, a visual-enrichment-data distribution module 120₁, one or more computer processors 145, and storage medium 130, which is a non-transitory, computer-readable medium. The one or more computer processors 145 are operative to execute program instructions 160₁ stored in the storage medium 130. The program instructions 160₁, which are represented schematically in FIG. 3, include four groups of program instructions: GPI01, GPI02, GPI03 and GPI04, where each group of instructions GPI01 . . . GPI04 includes program instructions for carrying out a portion of a method. The four groups comprise:
a. Group of program instructions GPI01 including program instructions for causing the video-content-item distribution module 110 to cause the displaying of a content item 201 by a content playing device 141.
b. Group of program instructions GPI02 including program instructions for causing the visual-enrichment-data distribution module 120₁ to determine, during the displaying of the content item 201 by the content playing device 141, related content 285 having a connection to the displayed content item 201, the determined related content 285 including multiple content units 286, where each content unit 286 (i) is either a content item or a video segment that is a portion of a larger video content item, (ii) has a connection to the displayed content item 201, (iii) is independent of all other content units 286 included in the related content 285, and (iv) is not included in the displayed content item 201.
c. Group of program instructions GPI03 including program instructions for causing the visual-enrichment-data distribution module 120₁ to cause an option to display the related content 285 to be presented to the user 90. As discussed earlier, the ‘option to display’ can include a go/no-go option 282 and/or sequence options for displaying the multiple related content items 286 within the related content 285.
d. Group of program instructions GPI04 including program instructions for causing the visual-enrichment-data distribution module 120₁ to cause the related content 285 to be displayed by the content playing device 141 in response to acceptance of the option by the user 90, where the displaying of the related content 285 includes displaying all of the plurality of content units 286 included in the related content 285 one after another.

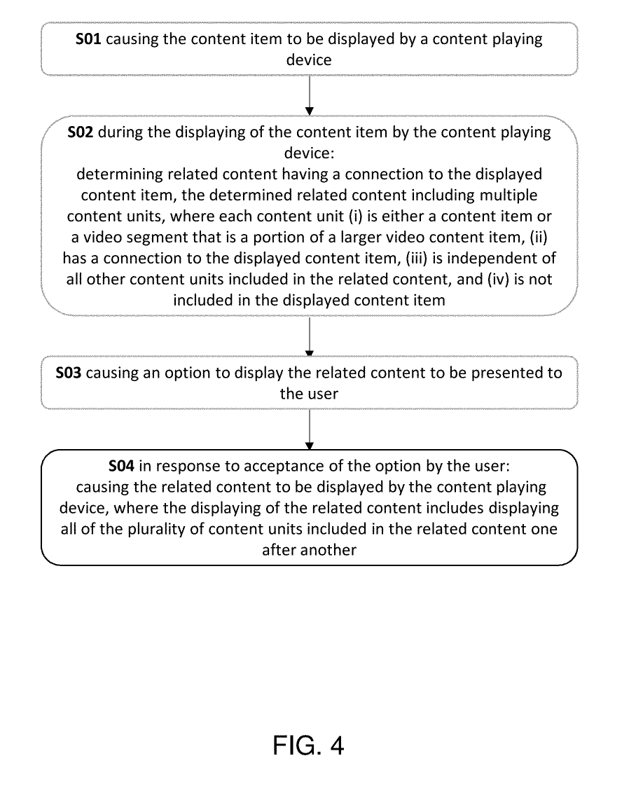

Referring now to FIG. 4, a method is disclosed according to embodiments, for enhancing user experience for a user 90 consuming a content item 201. The method, as shown in the flow chart of FIG. 4, comprises the following steps:
a. Step S01, causing the content item 201 to be displayed by a content playing device 141.
b. Step S02, during the displaying of the content item 201 by the content playing device 141, determining related content 285 having a connection to the displayed content item 201, the determined related content 285 including multiple content units 286, where each content unit 286 (i) is either a content item or a video segment that is a portion of a larger video content item, (ii) has a connection to the displayed content item 201, (iii) is independent of all other content units 286 included in the related content 285, and (iv) is not included in the displayed content item 201.
c. Step S03, causing an option to display the related content 285 to be presented to the user 90. As discussed earlier, the ‘option to display’ can include a go/no-go option 282 and/or sequence options for displaying the multiple related content items 286 within the related content 285.
d. Step S04, in response to acceptance of the option by the user 90, causing the related content 285 to be displayed by the content playing device 141, where the displaying of the related content 285 includes displaying all of the plurality of content units 286 included in the related content one after another.

Any of the steps in the method, and in fact any of the steps in any of the methods disclosed herein, can be implemented in a system 100 for distributing video content as disclosed herein.

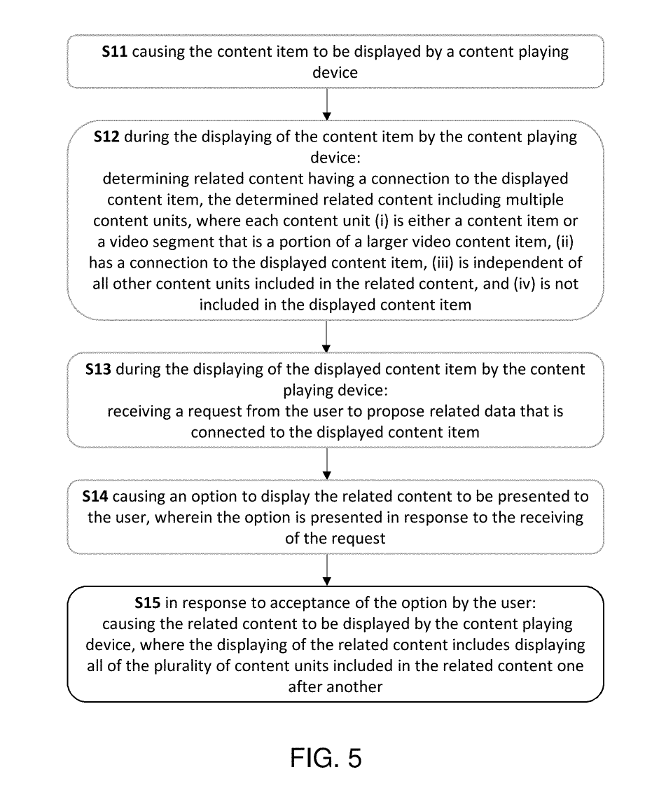

The method of FIG. 4 can also comprise, during the displaying of the displayed content item by the content playing device, receiving a request from the user to propose related data that is connected to the displayed content item, and thus the presenting of the option of Step S03 is done in response to the receiving of the request. The flowchart of FIG. 5 shows the method including the additional step. The overall method, as shown in the flow chart of FIG. 5, comprises the following steps:
a. Step S11 (same content as Step S01), causing the content item 201 to be displayed by a content playing device 141.
b. Step S12 (same content as Step S02), during the displaying of the content item 201 by the content playing device 141, determining related content 285 having a connection to the displayed content item 201, the determined related content 285 including multiple content units 286, where each content unit 286 (i) is either a content item or a video segment that is a portion of a larger video content item, (ii) has a connection to the displayed content item 201, (iii) is independent of all other content units 286 included in the related content 285, and (iv) is not included in the displayed content item 201.
c. Step S13, during the displaying of the displayed content item 201 by the content playing device 141, receiving a request from the user 90 to propose related data that is connected to the displayed content item 201.
d. Step S14, causing an option to display the related content 285 to be presented to the user 90, wherein the option is presented in response to the receiving of the request.
e. Step S15 (same content as Step S04), in response to acceptance of the option by the user 90, causing the related content 285 to be displayed by the content playing device 141, where the displaying of the related content 285 includes displaying all of the plurality of content units 286 included in the related content one after another.

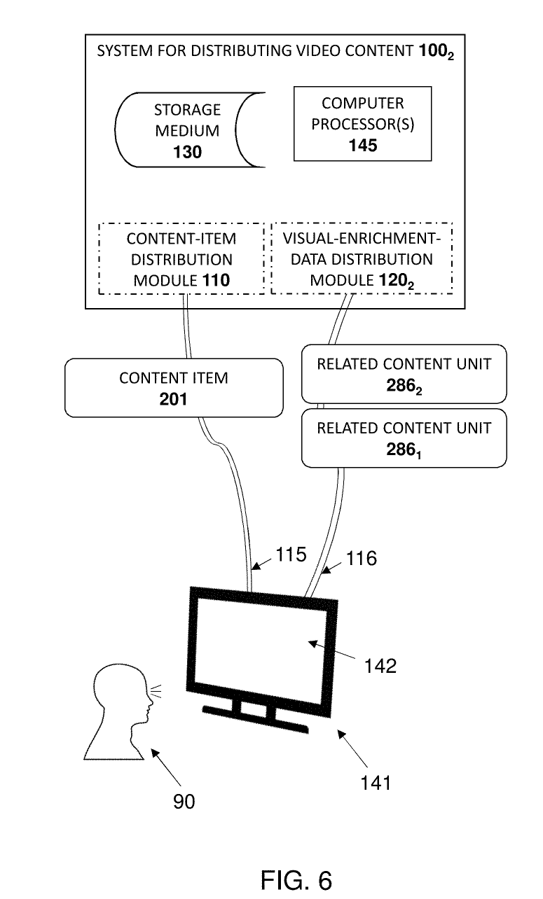

Referring now to FIG. 6, a system 100₂ for distributing video content—in accordance with the ‘second embodiment’ disclosed herein—is illustrated. The system 100₂ is similar to the system 100₁ illustrated in FIG. 1, except that instead of proposing ready-made sequences of related content units 285 as in FIG. 1, the visual-enrichment-data distribution module 120₂ of FIG. 6 is operable to enable the user 90 to construct his own preferred sequence of multiple related content units 286₁, 286₂, etc, by individually selecting and optionally also ordering the desired content units. This difference reflects a key difference between the first and second embodiments, as discussed earlier in this disclosure.

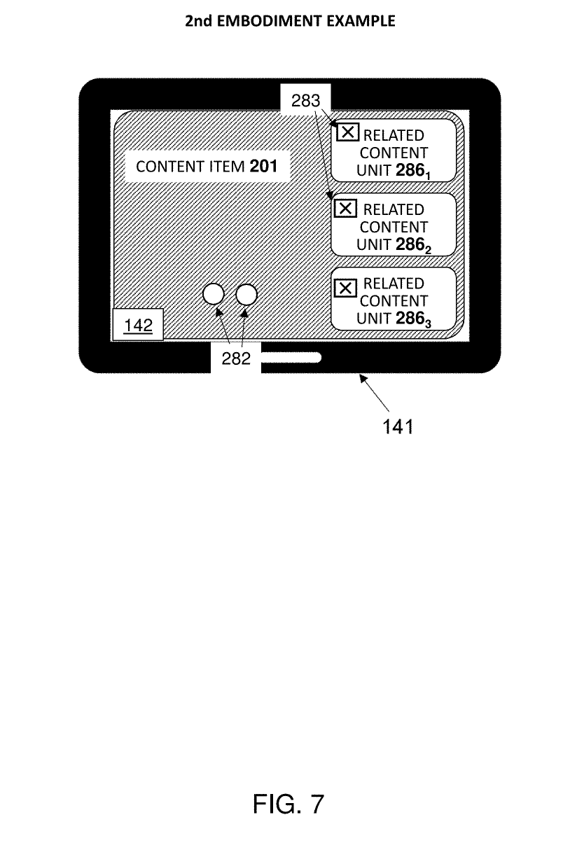

FIG. 7 shows a content-playing device 141 with a screen 142 on which a content item 201 is being displayed. In the non-limiting example of FIG. 7, recommendations for three related content units (RCUs) 286₁, 286₂ and 286₃ are presented to the user 90. The criteria for determining related content units for recommending were discussed earlier in this disclosure and are well known in the art. The recommendations are presented to the user either because the user instructed the visual-enrichment-data distribution module 120₂ to offer them, or because the user's profile indicates that the user always prefers to view recommendations. In other examples, more than 3 or fewer than 3 recommendations can be presented. An input field for Go/no-go options 282 (or play/cancel or any similar terminology) may be offered to user 90 to allow acceptance or rejection of viewing enriching content at the present time. Selecting ‘go’ instructs the visual-enrichment-data distribution module 120₂ to display all of the related content units 286 that are currently selected (i.e. whose corresponding input field 283 is selected). Selecting ‘no’ cancels the possibility of displaying the recommended related content units 286. Each related content unit 286 in FIG. 7 is accompanied by an RCU input field 283. As illustrated, the RCU input field 283 can be a checkbox so as to allow the user a yes/no decision on each individual RCU 286. A checkbox is not mandatory—instead, any kind of input-enabling element can be used. For example, the entire graphical or textual representation of each recommended RCU 286 can be selectable with a cursor controlled by a mouse click or a remote-control button-press, or by tapping with a finger or stylus in the case of screen 142 being a touchscreen. In some implementations, the order of selecting/clicking/tapping can be used to indicate the desired order of displaying the individuals RCU's 286. For example, a user might first touch or click the checkbox 283 or entire textual or graphical representation of 286₂, then of 286₃, and then of 286₁, thus indicating the user's preferred displaying sequence of ‘286₂, 286₃, 286₁’. In another example, the user may select 286₃ and then 286₁, and then the ‘go’ option of Go/no-go option buttons 282, which would be interpreted by the visual-enrichment-data distribution module 120₂ as ‘display 286₃ and then 286₁ in that order’—in other words, the second recommended RCU 286₂ would not be displayed. In other implementations, a user can be given the ability to move (using a pointing device such as a mouse or remote-control, or alternatively using a finger or stylus on a touchscreen) the graphical or textual representations of the individual RCU's 286 around on the screen 142 so as to put then in the desired order of displaying. In yet other implementations, a user can be given the ability to move the graphical or textual representations of the RCUs 286 into an area of the screen 142 designated for building a sequence of RCU's to be displayed, for example upon the user using the ‘go’ button of the Go/no-go input field 282.

In some examples, the visual-enrichment-data distribution module 120 may begin to (a) display all RCUs 286 as soon as the user has selected all of them, and/or (b) display only those RCUs 286 selected so far by the user (if fewer than the total number recommended on-screen) after a predetermined amount of time has passed since the last selection operation by the user of an RCU 286, for example 5 seconds or 10 seconds. Such features may be provided in addition to providing the “Go/no go” buttons or instead of them. It will be obvious to the skilled artisan that other combinations of onscreen controls and options are possible in accordance with the technical capabilities of the visual-enrichment-data distribution module 120₂.

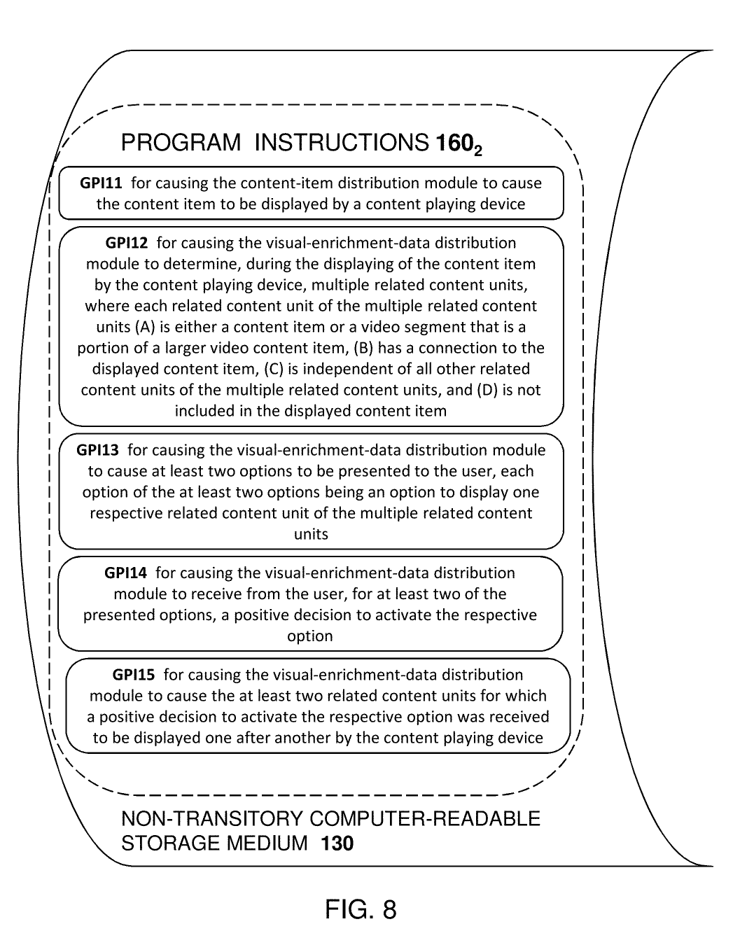

We now refer to FIG. 8 in combination with FIG. 6. The system 100₂ for distributing video content, according to some embodiments, comprises a video-content-item distribution module 110, a visual-enrichment-data distribution module 120₂, one or more computer processors 145, and storage medium 130, which is a non-transitory, computer-readable medium. The one or more computer processors 145 are operative to execute program instructions 160₂ stored in the storage medium 130. The program instructions 160₂, which are represented schematically in FIG. 8, include five groups of program instructions: GPI11, GPI12, GPI13, GPI14 and GPI15, where each group of instructions GPI11 . . . GPI15 includes program instructions for carrying out a portion of a method. The five groups comprise:
a. Group of program instructions GPI11 including program instructions for causing the video-content-item distribution module 110 to cause the displaying of a content item 201 by a content playing device 141.
b. Group of program instructions GPI12 including program instructions for causing the visual-enrichment-data distribution module 120₂ to determine, during the displaying of the content item 201 by the content playing device 141, multiple related content units 286, where each related content unit 286 of the multiple related content units 286 (A) is either a content item or a video segment that is a portion of a larger video content item, (B) has a connection to the displayed content item, (C) is independent of all other related content units 286 of the multiple related content units 286, and (D) is not included in the displayed content item 201.
c. Group of program instructions GPI13 including program instructions for causing the visual-enrichment-data distribution module 120₂ to cause at least two options to be presented to the user 90, each option of the at least two options being an option to display one respective related content unit 286 of the multiple related content units 286.
d. Group of program instructions GPI14 including program instructions for causing the visual-enrichment-data distribution module 120₂ to receive from the user 90, for at least two of the presented options, a positive decision to activate the respective.
e. Group of program instructions GPI15 including program instructions for causing the visual-enrichment-data distribution module 120₂ to cause the at least two related content units 286 for which a positive decision to activate the respective option was received to be displayed one after another by the content playing device 141.

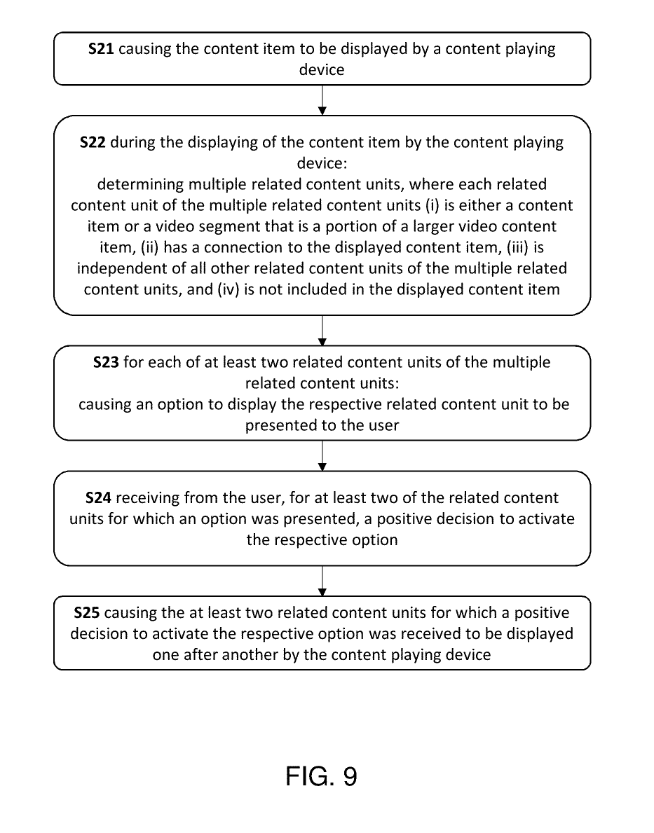

Referring now to FIG. 9, a method is disclosed according to embodiments, for enhancing user experience for a user 90 consuming a content item 201. The method, as shown in the flow chart of FIG. 9, comprises the following steps:
a. Step S21, causing the content item 201 to be displayed by a content playing device 141.
b. Step S22, during the displaying of the content item 201 by the content playing device 141, determining multiple related content units 286, where each related content unit 286 of the multiple related content units 286 (i) is either a content item or a video segment that is a portion of a larger video content item, (ii) has a connection to the displayed content item, (iii) is independent of all other related content units 286 of the multiple related content units 286, and (iv) is not included in the displayed content item 201.
c. Step S23, for each of at least two related content units of the multiple related content units 286, causing an option to display the respective related content unit 286 to be presented to the user 90.
d. Step S24, receiving from the user 90, for at least two of the related content units 286 for which an option was presented, a positive decision to activate the respective option.
e. Step S25, causing the at least two related content units 286 for which a positive decision to activate the respective option was received to be displayed one after another by the content playing device 141.

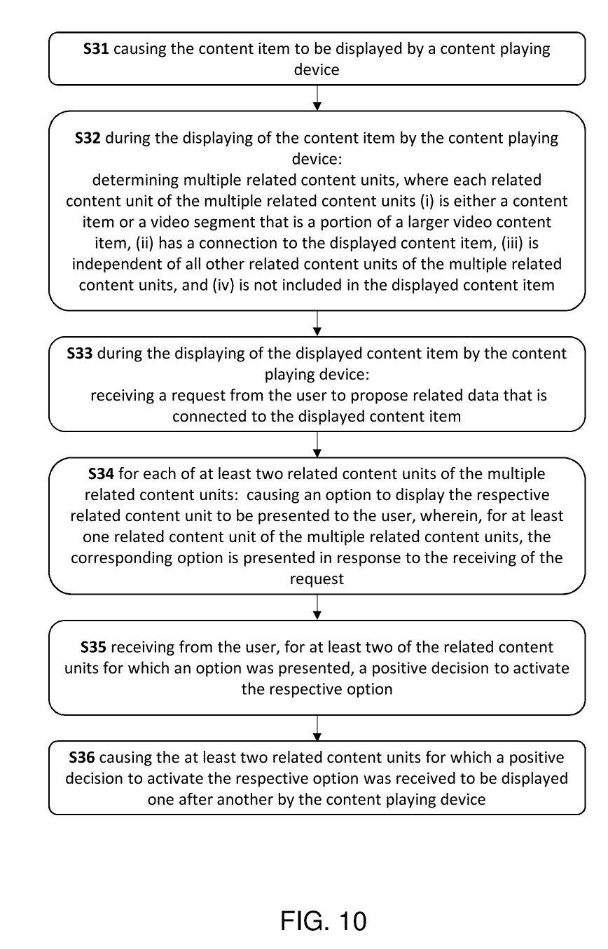

The method of FIG. 9 can also comprise, during the displaying of the displayed content item by the content playing device, receiving a request from the user 90 to propose related data that is connected to the displayed content item 201, wherein, for at least one related content unit 286 of the multiple related content units 286, the presenting of the corresponding option is done in response to the receiving of the request. The flowchart of FIG. 10 shows the method of FIG. 9 with the additional step, and comprises the following steps:
a. Step S31 (same content as Step S21), causing the content item 201 to be displayed by a content playing device 141.
b. Step S32 (same content as Step S22), during the displaying of the content item 201 by the content playing device 141, determining multiple related content units 286, where each related content unit 286 of the multiple related content units 286 (i) is either a content item or a video segment that is a portion of a larger video content item, (ii) has a connection to the displayed content item, (iii) is independent of all other related content units 286 of the multiple related content units 286, and (iv) is not included in the displayed content item.
c. Step S33, during the displaying of the displayed content item 201 by the content playing device 141, receiving a request from the user 90 to propose related data that is connected to the displayed content item 201.
d. Step S34, for each of at least two related content units 286 of the multiple related content units 286, causing an option to display the respective related content unit 286 to be presented to the user 90, wherein, for at least one related content unit 286 of the multiple related content units 286, the corresponding option is presented in response to the receiving of the request.
e. Step S35 (same content as step S24), receiving from the user 90, for at least two of the related content units 286 for which an option was presented, a positive decision to activate the respective option.
f. Step S36 (same content as step S25), causing the at least two related content units 286 for which a positive decision to activate the respective option was received to be displayed one after another by the content playing device 141.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

### Definitions

This disclosure should be interpreted according to the definitions below.

In case of a contradiction between the definitions in this Definitions section and other sections of this disclosure, this section should prevail.

In case of a contradiction between the definitions in this section and a definition or a description in any other document, including in another document included in this disclosure by reference, this section should prevail, even if the definition or the description in the other document is commonly accepted by a person of ordinary skill in the art.
1. “content”—information and experiences that are directed towards an end-user or audience.
2. “content item”—a stand-alone unit of content that can be referred to and identified by a single reference and can be retrieved and played independently of other content. For example, a movie, a still image, a paragraph of text, or a TV series.
3. “media content item”—a content item that contains media content. For example, a movie, a TV program, an episode of a TV series, a video clip, an animation, an audio clip, or a still image.
4. “non-media content item”—a content item that is not a media content item. For example, a paragraph of text.
5. “audio content item”—a media content item that contains only an audio track hearable using a speaker or a microphone.
6. “video content item”—a media content item that contains a visual track viewable on a screen. A video content item may or may not additionally contain an audio track.
7. “audio” and “aural” are used as synonyms herein.
8. “video” and “visual” are used as synonyms herein.
9. “audio channel” and “audio track” are used as synonyms herein. Both refer to an audio component of a media content item.
10. “video channel” and “video track” are used as synonyms herein. Both refer to a video component of a media content item. A still image is a special case of video track.
11. “content playing device”—a device that is capable of playing or displaying at least some content items. For example, a graphic engine that is capable of displaying paragraphs of text, a combined video/audio player that is capable of playing in parallel both the video channel and the audio channel of at least some media content items.
12. “media playing device”—a device that is capable of playing at least some media content items. For example, an audio-only player that is capable of playing at least some audio content items, a video-only player that is capable of playing the video track of at least some video content items, a combined video/audio player that is capable of playing in parallel both the video channel and the audio channel of at least some media content items.
13. “playing a media content item”—outputting at least one of a video channel and an audio channel of the media content item to a visual output device (for example a TV screen) or an audio output device (for example a speaker or headphones). If the media content item is a still image, then playing it means outputting the still image to a visual output device. If the media content item is a video content item that has both a video channel and an audio channel, then playing it means outputting both the video channel and the audio channel to a visual output device and an audio output device, respectively. Pausing a video content item in the middle of playing is considered playing it. Also, showing the last frame of a video content item after it was played to its end is considered playing the video content item.
14. “displaying a media content item”—outputting a video channel of the media content item to a visual output device (for example a TV screen). If the media content item is a still image, then displaying it means outputting the still image to a visual output device. Pausing a video content item in the middle of playing it is considered displaying it. Also, showing the last frame of a video content item after it was played to its end is considered displaying the video content item.
15. “displaying a non-media content item”—outputting a visual image of the non-media content item to a visual output device (for example outputting a visual image of a paragraph of text to a computer screen).
16. “entity”—something that exists as itself, as a subject or as an object, actually or potentially, concretely or abstractly, physically or not. It need not be of material existence. In particular, abstractions and legal fictions are regarded as entities. There is also no presumption that an entity is animate, or present. Specifically, an entity may be a person entity, a location entity, an organization entity, a media content item entity, a topic entity or a group entity. Note that the term “entity” does not refer to the text referencing the subject or the object, but to the identity of the subject or the object.
17. “person entity”—a real person entity, a character entity or a role entity.
18. “real person entity”—a person that currently lives or that had lived in the past, identified by a name (e.g. John Kennedy) or a nickname (e.g. Fat Joe).
19. “character entity”—a fictional person that is not alive today and was not alive in the past, identified by a name or a nickname. For example, “Superman”, “Howard Roark”, etc.
20. “role entity”—a person uniquely identified by a title or by a characteristic. For example “the 23rd president of the United States”, “the oldest person alive today”, “the tallest person that ever lived”, “the discoverer of the penicillin”, etc.
21. “location entity”—an explicit location entity or an implicit location entity.
22. “explicit location entity”—a location identified by a name (e.g. “Jerusalem”,
“Manhattan 6th Avenue”, “Golani Junction”, “the Dead Sea”) or by a geographic locator (e.g. “ten kilometers north of Golani Junction”, “100 degrees East, 50 degrees North”).
23. “implicit location entity”—a location identified by a title or a by a characteristic (e.g. “the tallest mountain peak in Italy”, “the largest lake in the world”).
24. “organization entity”—an organization identified by a name (e.g. “the United Nations”, “Microsoft”) or a nickname (e.g. “the Mossad”).
25. “media content item entity”—A media content item identified by a name (e.g. “Gone with the Wind” is a media content item entity that is a movie, and “Love Me Do” is a media content item entity that is a song).
26. “topic entity”—a potential subject of a conversation or a discussion. For example, the probability that Hillary Clinton will win the presidential election, the current relations between Russia and the US, the future of agriculture in OECD countries.
27. “group entity”—a group of entities of any type. The different member entities of a group may be of different types.
28. “nickname of an entity”—any name by which an entity is known which is not its official name, including a pen name, a stage name and a name used by the public or by a group of people to refer to it or to address it.
29. “named entity”—An entity that is identified by a name or a nickname and not by other types of description. For example, “Jerusalem” is a named entity, but “the tallest building in Jerusalem” is not a named entity (even though it is a perfectly valid entity, that is uniquely identified).
30. “subtitles”—Text derived from either a transcript or a screenplay of a dialog or commentary in movies, television programs and the like, displayable on the screen while the movie or program is being played. Subtitles can either be a translation of text spoken in the movie or program into a different language, or a rendering of text in the same language spoken in the movie or program. Subtitles may include added information to help viewers who are deaf or hard of hearing to follow the dialog or commentary, or to help people who cannot understand the spoken dialogue or commentary, or who have accent recognition problems. The subtitles can either be pre-rendered with the video or separately provided as either graphics or text to be rendered and overlaid by a rendering device.
31. “video shot” (also referred to herein as “shot”)—A continuous sequence of frames within a video content item that were continuously recorded by the same camera. A video shot is a physical entity that does not deal with the semantic meaning of its content.
32. “video scene” (also referred to herein as “scene”)—A collection of one or more semantically-related and temporally adjacent video shots depicting and conveying a high-level concept or story. In other words, a video scene is a semantic entity that is a continuous portion of a video content item and has an independent identity of its own. For example, one news item of a news program or a car chase scene of an action movie. Typically there are multiple video scenes within a video content item, but a video scene may also be the only one within its video content item, as may be the case for a short music video clip.
33. “video segment” (also referred to herein as “segment”)—a continuous portion of a video content item that is strictly smaller than the enclosing video content item. A video segment may coincide with a video shot or with a video scene, but does not have to. That is—a video segment may be a single shot, multiple shots, a portion of a shot, multiple shots plus a portion of a shot, a single scene, multiple scenes, a portion of a scene, or multiple scenes plus a portion of a scene.
   It should be emphasized that a video segment extracted from its enclosing video content item and put back into a library or collection of video content items as a stand-alone video item, is no longer considered to be a video segment and becomes a video content item of its own. This is so even if the enclosing video content item from which the segment was extracted is available in the same library or collection. That is, a car chasing scene extracted from a movie and posted as a short video in YouTube is no longer a video segment for the purpose of the present solution.
34. “content component” or “content unit”—A content item or a video segment.
35. “content component/unit A is independent of content component/unit B”—Components/units A and B are not both included in a common content item.
   For example, a first episode of the TV series Friends is not independent of a second episode of the same TV series, as both episodes are included in that TV series, which is uniquely identified by the reference “the Friends TV series”. Similarly, a first video segment of the movie Titanic is not independent of a second video segment of the same movie, as both video segments are included in that movie, which is uniquely identified by the reference “the Titanic movie”. However, a video segment containing a car chase scene from the movie “Fast and Furious 8” is independent of a video segment containing a car chase scene from the movie “Lethal Weapon 4”, as there is no content item that includes both.
   Note that if component/unit A is independent of component/unit B then, by definition, component/unit B is independent of component/unit A.
36. “strictly larger”—larger and not equal to.
37. “or”—A logical operator combining two Boolean input conditions into a Boolean compound condition, such that the compound condition is satisfied if and only if at least one of the two input conditions is satisfied. In other words, if condition C=condition A or condition B, then condition C is not satisfied when both condition A and condition B are not satisfied, but is satisfied in each of the following cases: (i) condition A is satisfied and condition B is not satisfied, (ii) condition A is not satisfied and condition B is satisfied, and (iii) both condition A and condition B are satisfied.
38. “one of A and B”—If A and B are specific items, then “one of A and B” is equivalent to “only A or only B, but not both”. For example, “one of John and Mary” is equivalent to “only John or only Mary, but not both John and Mary”. If A and B are categories, then “one of A and B” is equivalent to “only one of A or only one of B, but not both one of A and one of B”. For example, “one of a dog and a cat” is equivalent to “only one dog or only one cat, but not both one dog and one cat”.
   Similarly, if A and B are specific items, then “at least one of A and B” is equivalent to “only A or only B, or both A and B”. For example, “at least one of John and Mary” is equivalent to “only John or only Mary, or both John and Mary”. If A and B are categories, then “at least one of A and B” is equivalent to “only at least one of A or only at least one of B, or both at least one of A and at least one of B”. For example, “at least one of a dog and a cat” is equivalent to “only at least one dog or only at least one cat, or both at least one dog and at least one cat”.
   Note that in “one of dogs and cats”, “dogs” and “cats” are not categories but specific groups (i.e. specific items). Therefore, “one of dogs and cats” is equivalent to “only dogs or only cats, but not both dogs and cats” Similarly, “at least one of dogs and cats” is equivalent to “only dogs or only cats, or both dogs and cats”.
   If A, B and C are specific items, then “one of A, B and C” is equivalent to “only A or only B or only C, but not a combination of two or three members of the group consisting of: A, B and C”, and “at least one of A, B and C” is equivalent to “only A or only B or only C, or any combination of two or three members of the group consisting of: A, B and C”.
   If A, B and C are categories, then “one of A, B and C” is equivalent to “only one of A or only one of B or only one of C, but not a combination of two or three members of the group consisting of: one of A, one of B and one of C”, and “at least one of A, B and C” is equivalent to “only at least one of A or only at least one of B or only at least one of C, or any combination of two or three members of the group consisting of: one of A, one of B and one of C”.
   If the list following the “one of” or the “at least one of” contains more than three members, then the previous definitions are again applicable, with the appropriate modifications that extrapolate the above logic.
   Note that “one or more of” is equivalent to “at least one of”, and the two terms are synonyms.

1. A method for enhancing user experience for a user consuming a content item by displaying a sequence of multiple content units related to the content item, the method comprising:
a) causing the content item to be displayed by a content playing device;
b) during the displaying of the content item by the content playing device, determining multiple related content units, where each related content unit of the multiple related content units (i) is either a content item or a video segment that is a portion of a larger video content item, (ii) has a connection to the displayed content item, (iii) is independent of all other related content units of the multiple related content units, and (iv) is not included in the displayed content item;
c) for each of at least two related content units of the multiple related content units, causing an option to display the respective related content unit to be presented to the user;
d) receiving from the user, for at least two of the related content units for which an option was presented, a positive decision to activate the respective option; and
e) causing the at least two related content units for which a positive decision to activate the respective option was received to be displayed one after another by the content playing device.

2. The method of claim 1, wherein the displaying of all of the at least two related content units one after another includes displaying all of the at least two related content units in sequence, without receiving any input from the user between the displaying of successive related content units.

3. The method of claim 2, wherein one of the at least two displayed related content units is a textual content item and is displayed for a pre-defined time interval.

4. The method of claim 2, wherein one of the at least two displayed related content units is a textual content item and is displayed for a time interval that depends on one or more characteristics of the textual content item.

5. The method of claim 1, wherein the displaying of the at least two related content units one after another includes receiving confirmation from the user between the displaying of successive related content units.

6. The method of claim 1, wherein for at least one point in time the displayed content item and one of the at least two displayed related content units are displayed simultaneously.

7. The method of claim 1, wherein the order according to which the at least two displayed related content units are displayed is determined according to the order of receiving the respective positive decisions from the user.

8. The method of claim 1, wherein the order according to which the at least two displayed related content units are displayed is automatically determined, without being affected by user inputs.

9. The method of claim 8, wherein the order according to which the at least two displayed related content units are displayed is determined based on corresponding calendar times associated with the at least two displayed related content units.

10. A system for distributing video content, comprising:
a. a content-item distribution module;
b. a visual-enrichment-data distribution module;
c. one or more computer processors; and
d. a non-transitory computer-readable storage medium storing program instructions for execution by the one or more computer processors, the non-transitory computer-readable storage medium having stored therein:
i. first program instructions that, when executed by the one or more processors, cause the content-item distribution module to cause the content item to be displayed by a content playing device;
ii. second program instructions that, when executed by the one or more processors, cause the visual-enrichment-data distribution module to determine, during the displaying of the content item by the content playing device, multiple related content units, where each related content unit of the multiple related content units (A) is either a content item or a video segment that is a portion of a larger video content item, (B) has a connection to the displayed content item, (C) is independent of all other related content units of the multiple related content units, and (D) is not included in the displayed content item;
iii. third program instructions that, when executed by the one or more processors, cause the visual-enrichment-data distribution module to cause at least two options to be presented to the user, each option of the at least two options being an option to display one respective related content unit of the multiple related content units;
iv. fourth program instructions that, when executed by the one or more processors, cause the visual-enrichment-data distribution module to receive from the user, for at least two of the presented options, a positive decision to activate the respective option; and
v. fifth program instructions that, when executed by the one or more processors, cause the visual-enrichment-data distribution module to cause the at least two related content units for which a positive decision to activate the respective option was received to be displayed one after another by the content playing device.

11. A method for enhancing user experience for a user consuming a content item by displaying a sequence of multiple content units related to the content item, the method comprising:
a. causing the content item to be displayed by a content playing device;
b. during the displaying of the content item by the content playing device, determining related content having a connection to the displayed content item, the determined related content including multiple content units, where each content unit (i) is either a content item or a video segment that is a portion of a larger video content item, (ii) has a connection to the displayed content item, (iii) is independent of all other content units included in the related content, and (iv) is not included in the displayed content item;
c. causing an option to display the related content to be presented to the user; and
d. in response to acceptance of the option by the user, causing the related content to be displayed by the content playing device, where the displaying of the related content includes displaying all of the plurality of content units included in the related content one after another.

12. The method of claim 11, wherein the displaying of all the content units included in the related content one after another includes displaying all of the content units in sequence, without receiving any input from the user between the displaying of successive content units.

13. The method of claim 12, wherein one of the content units included in the related content is a textual content item, and during the displaying of the related content, the textual content item is displayed for a pre-defined time interval.

14. The method of claim 12, wherein one of the content units included in the related content is a textual content item, and, during the displaying of the related content, the textual content item is displayed for a time interval that depends on one or more characteristics of the textual content item.

15. The method of claim 11, wherein the displaying of all the content units of the related content one after another includes receiving confirmation from the user between the displaying of successive content units.

16. The method of claim 11, further comprising additionally causing at least one option to display only one of the multiple content units included in the related content to be displayed to the user.

17. The method of claim 11, wherein the determining of the related content having a connection to the displayed content item is based on a user preference obtained by analyzing viewing history of the user.

18. The method of claim 11, wherein the determining of the related content having a connection to the displayed content item is based on a user preference manually provided by the user.

19. The method of claim 11, wherein for at least one point in time the displayed content item and the related content are being displayed simultaneously.

20. A system for distributing video content, comprising:
a. a content-item distribution module;
b. a visual-enrichment-data distribution module;
c. one or more computer processors; and
d. a non-transitory computer-readable storage medium storing program instructions for execution by the one or more computer processors, the non-transitory computer-readable storage medium having stored therein:
i. first program instructions that, when executed by the one or more processors, cause the content-item distribution module to cause the content item to be displayed by a content playing device;
ii. second program instructions that, when executed by the one or more processors, cause the visual-enrichment-data distribution module to determine, during the displaying of the content item by the content playing device, related content having a connection to the displayed content item, the determined related content including multiple content units, where each content unit (A) is either a content item or a video segment that is a portion of a larger video content item, (B) has a connection to the displayed content item, (C) is independent of all other content units included in the related content, and (D) is not included in the displayed content item;
iii. third program instructions that, when executed by the one or more processors, cause the visual-enrichment-data distribution module to cause an option to display the related content to be presented to the user; and
iv. fourth program instructions that, when executed by the one or more processors, cause the visual-enrichment-data distribution module to cause the related content to be displayed by the content playing device in response to acceptance of the option by the user, where the displaying of the related content includes displaying all of the plurality of content units included in the related content one after another.
